(19) United States
(12) Patent Application Publication
(10) Pub. No.: US 2017/0085117 A1
(43) Pub. Date: Mar. 23, 2017

(54) BATTERY-SHAPED WIRELESS DEVICE

(71) Applicant: KABUSHIKI KAISHA TOSHIBA, Tokyo (JP)

(72) Inventors: Hiroshi OTA, Misato Saitama (JP); Hirofumi OMOTE, Adachi Tokyo (JP); Yasutomo SAKURAI, Kawasaki Kanagawa (JP)

(21) Appl. No.: 15/061,988

(22) Filed: Mar. 4, 2016

Related U.S. Application Data
(60) Provisional application No. 62/221,829, filed on Sep. 22, 2015.

(51) Int. Cl. H02J 7/02; H02J 7/04; G08B 21/18; G08B 3/10; G08C 17/02; H04W 4/00

(52) U.S. Cl. CPC H02J 7/025; G08C 17/02; H04W 4/008; G08B 21/182; G08B 3/1083; H02J 7/045; H02J 7/047; H02J 2007/0096

(57) ABSTRACT

A battery-shaped wireless device includes a housing having an exterior shape of a standardized battery, a wireless module disposed in the housing and configured to generate a wireless signal, and a control circuit configured to cause the wireless module to generate the wireless signal. The battery-shaped wireless device can fit in a space designed for a standardized battery.

### CROSS-REFERENCE TO RELATED APPLICATION

This application is based upon and claims the benefit of priority from U.S. Provisional Patent Application No. 62/221,829, filed on Sep. 22, 2015, the entire contents of which are incorporated herein by reference.

### FIELD

Embodiments described herein relate generally to a battery-shaped wireless device.

### BACKGROUND

Electronic apparatuses capable of wireless connection to another electronic apparatus using a wireless communication card or the like are known. Such electronic apparatuses usually require a card slot into which the wireless communication card is inserted.

### BRIEF DESCRIPTION OF THE DRAWINGS

FIG. 1 illustrates an electronic apparatus of an embodiment, including a wireless device therein.

FIG. 2 illustrates the wireless device according to an embodiment.

FIG. 3 is a block diagram of a system configuration of the wireless device.

FIG. 4 is a cross-sectional diagram of the wireless device illustrated in FIG. 2 taken along a line segment F4-F4 in FIG. 2.

FIG. 5 is a block diagram illustrating a system configuration of an external apparatus according to the embodiment.

FIG. 6 is a block diagram of a system configuration of another external apparatus according to the embodiment.

FIG. 7 illustrates a wireless device according to a first modification example.

FIG. 8 illustrates a wireless device according to a second modification example.

FIG. 9 illustrates a wireless device according to a third modification example.

FIG. 10 illustrates a wireless device according to a fourth modification example.

FIG. 11 is a block diagram of a system configuration of the wireless device according to the embodiment.

FIG. 12 illustrates an example of a management process for encryption key information according to the embodiment.

FIG. 13 illustrates a management process for encryption key information according to a first modification example.

FIG. 14 illustrates a management process for encryption key information according to a second modification example.

### DETAILED DESCRIPTION

According to an embodiment, a battery-shaped wireless device includes a housing having an exterior shape of a standardized battery, a wireless module disposed in the housing and configured to generate a wireless signal, and a control circuit configured to cause the wireless module to generate the wireless signal.

One or more embodiments of the wireless device (battery-shaped wireless device) are described below with reference to the drawings. In the description below, elements having the same or similar functions are described with the same reference symbol, and duplicate descriptions thereof might be omitted.

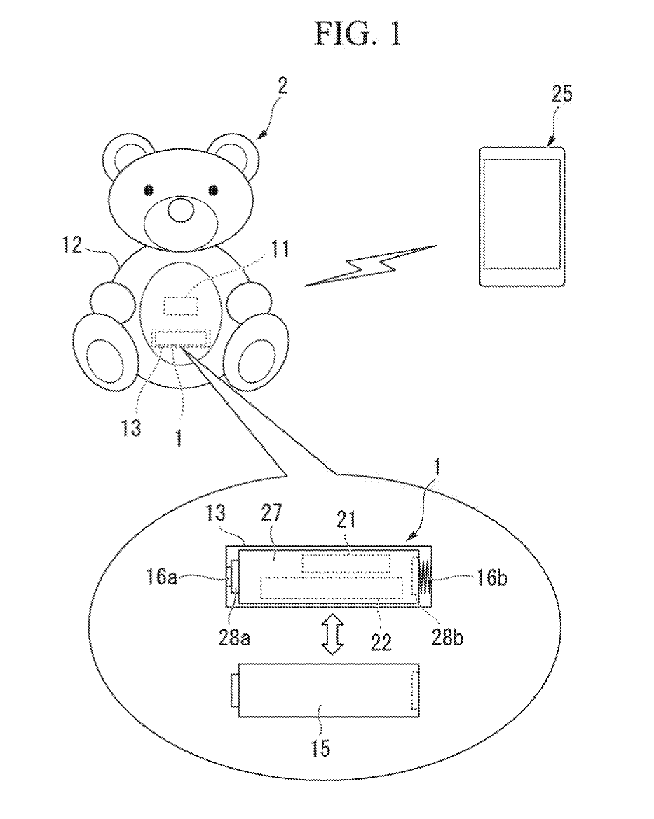

A wireless device 1 of an embodiment is described below with reference to FIG. 1 through FIG. 6. FIG. 1 illustrates an example of an electronic apparatus 2 including the wireless device 1.

As illustrated in FIG. 1, the electronic apparatus 2 is, for example, a stuffed toy including an electronic component 11 inside the electronic apparatus 2. The electronic component 11 may be a motor for moving the stuffed toy, a control component, a. speaker, or the like, but is not limited to these examples. Further, the electronic apparatus 2 is not limited to the stuffed toy. The electronic apparatus 2 may be widely applied to a variety of products, such as clocks, remote controllers, toys, key holders, lights, radios, and the like.

The electronic apparatus 2 includes a housing 12 that accommodates the electronic component 11. The housing 12 includes a battery housing 13. The battery housing 13 is capable of accommodating a battery 15 (normal battery 15) standardized by, for example, the International Electrotechnical Commission (ICE), the American National Standards Institute (ANSI), or Japan Industrial Standards (JIS). The battery housing 13 has a positive terminal (i.e., first terminal, first electric terminal) 16a that is contactable to a positive electrode of the normal battery 15, and a negative terminal (i.e., second terminal, second electric terminal) 16b that is contactable a negative electrode of the normal battery 15. The positive terminal 16a and the negative terminal 16b are disposed apart at both ends of the battery housing 13. The positive terminal 16a is electrically connected to the electronic component 11 of the electronic apparatus 2. The negative terminal 16b is electrically connected to ground. When the normal battery 15 is put in the battery housing 13, electric power is supplied to the electric component 11 the normal battery 15.

As illustrated in FIG. 1, the wireless device 1 of the present embodiment is a battery-shape wireless device having an external shape substantially the same as an external shape of the normal battery 15 (i.e., a standardized battery). The external shape of the normal battery 15 conforms to the standard specification for the standardized battery. For example, the standard specification for the standardized battery is standardized by one or more standards organizations such as ICE, ANSI, JIS or the like. Examples of the normal battery 15 are R20, R14, R6, R03, R1, SR41, SR43, SR44, SR54, SR55, 4SR44, LR41, LR43, CR1025, and CR1216. However, the examples of the normal battery 15 are not limited to the above examples. The wireless device 1 is an example of a “wireless communication battery”, a “wireless apparatus”, a “communication unit”, and an “electronic apparatus”. The wireless device 1 is configured to be accommodated in (i.e., attached to) the battery housing 13 of the electronic apparatus 2 as a substitute for the normal battery 15. That is, the wireless device 1 is configured to be disposed (e.g., put) between the positive terminal 16a and the negative terminal 16b of the battery housing 13, and the wireless device 1 is configured to be supported by the positive terminal 16a and the negative terminal 16b.

The wireless device 1 has a wireless module 21 and a battery 22. When the wireless device 1 is attached to the battery housing 13, the wireless device 1 supplies electric power to the electronic apparatus 2 as a substitute to the normal battery 15, and adds a wireless communication function to the electronic apparatus 2. That is, the electronic apparatus 2 can communicate wirelessly with an external apparatus (i.e., information processing device) 25. Here, the external apparatus 25 may be an electronic apparatus (e.g., user terminal) like a smart phone, tablet terminal, or portable computer, or a device that configures at least a part of an information processing system such as a detection system.

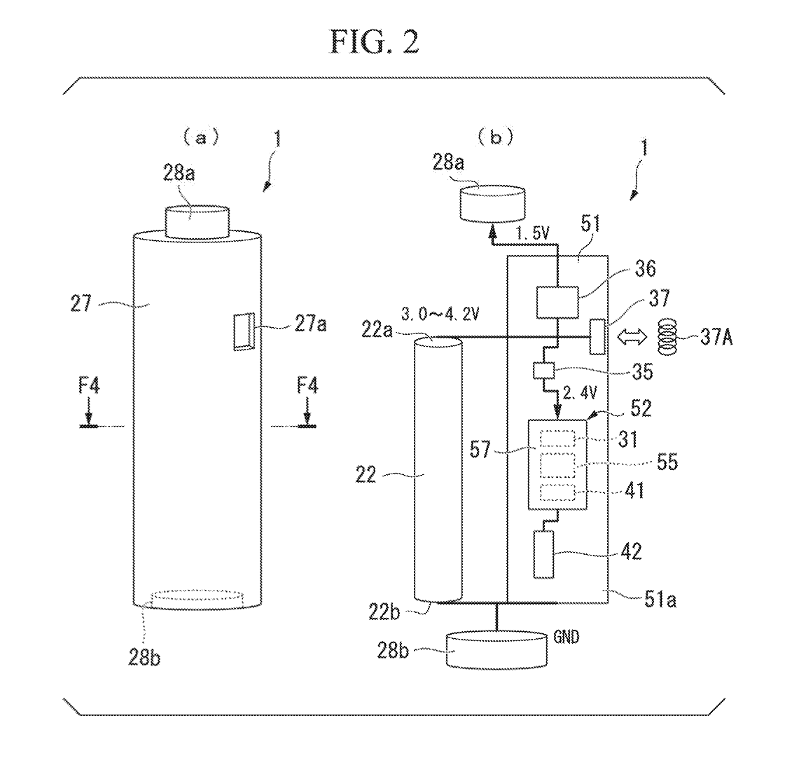

FIG. 2 illustrates a hardware configuration of the wireless device 1. (a) of FIG. 2 illustrates an external view of the wireless device 1, and (b) of FIG. schematically illustrates an internal configuration of the wireless device 1.

As illustrated in (a) of FIG. 2, the wireless device 1 includes a case 27. The case 27 includes a positive electrode terminal (i.e., first terminal, first electric terminal) 28a and a negative electrode terminal (i.e., second terminal, second electric terminal) 28b.

The case 27 has an external shape substantially same as (i.e., a size and shape substantially the same to) the external shape of the normal battery 15 standardized by, for example ICE, ANSI, or JIS. The case 27 (i.e., the wireless device 1) is capable of being accommodated in (e.g., capable of being attached to) the battery housing 13. The case 27 of the present embodiment has a cylindrical shape, having an external shape substantially similar to that of an AA battery, for example. At least a part of the case 27 is made from synthetic resin and allows an electromagnetic wave (e.g., a radio wave) from the wireless module 21 to pass. In the present embodiment, the case 27 is made from a fire resistant synthetic polymer, and allows an electromagnetic wave(e.g., a radio wave) from the wireless module 21 to pass.

The positive electrode terminal 28a and the negative electrode terminal 28b are conductive portions made from metal, and are electrically conductive. The positive electrode terminal 28a is provided in one end of the case 27. The positive electrode terminal 28a is contactable to the positive terminal 16a of the battery housing 13, and is configured to be electrically connected to the positive terminal 16a (refer to FIG. 1). The negative electrode terminal 28b is provided in the other end of the case 27. The negative electrode terminal 28b is contactable to the negative terminal 16b of the battery housing 13, and is configured to be electrically connected to the negative terminal 16b (refer to FIG. 1).

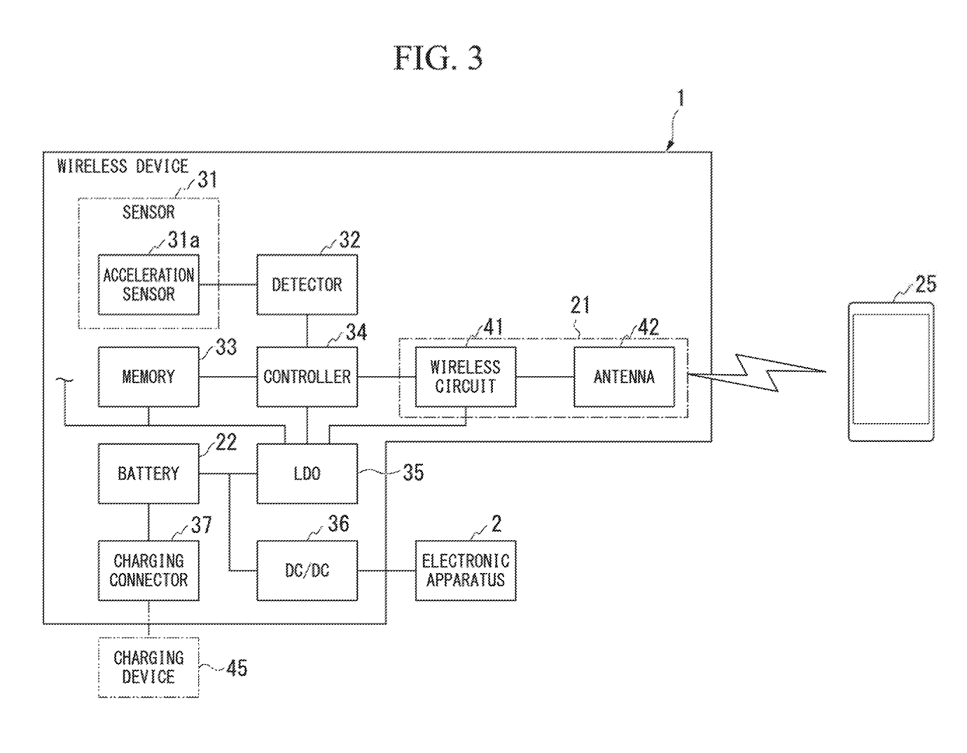

A system configuration of the wireless device 1 is described below. FIG. 3 illustrates a system configuration of the wireless device 1.

As illustrated in FIG. 3, the wireless device 1 includes a sensor 31, a detector 32, a memory 33, a controller 34, a wireless module 21, a battery 22, and electric power components 35, 36, and 37.

The sensor 31 includes an acceleration sensor 31a. The acceleration sensor 31a is an inertial sensor that measures acceleration, and detects force acting on the electric apparatus 2. That is, the acceleration sensor 31a can detect motion of the electric apparatus 2 by measuring acceleration. The acceleration sensor 31a of this embodiment is, for example, a three-axis acceleration sensor. That is, the acceleration sensor 31a measures acceleration in each of three substantially mutually orthogonal directions: an X-axis direction, a Y-axis direction, and a Z-axis direction. The acceleration sensor 31a outputs signals representing acceleration measurement results in each of the X-axis direction, the Y-axis direction, and the Z-axis direction to the detector 32.

The detector (e.g., detection circuit) 32 is configured by, for example, a part of circuitry that is included in a Micro Controller Unit (MCU) 55 (See FIG, 7). The detector 32 receives output from the sensor 31 (e.g., output from the acceleration sensor 31a). For example, the detector 32 detects motion of the electronic apparatus 2 based on the output from the acceleration sensor 31a. That is, the detector 32 detects motion of the electric apparatus 2 by comparing a measured value included in the output from the acceleration sensor 31a with a standard value set in advance.

In addition, the detector 32 of the present embodiment detects a frequency of movement of the electric apparatus 2 based on the output from the acceleration sensor 31a. For example, the detector 32 detects the frequency of movement of the electric apparatus 2 by counting the number of times a measured value included in the output from the acceleration sensor 31a exceeds a standard value set in advance. “Frequency of movement of the electronic apparatus” used here is the number of times the electronic apparatus 2 is moved in a unit time (i.e., unit period). The number of times the electronic apparatus 2 is moved can be deemed to be the number of times the apparatus 2 is used. The “frequency of movement of the electronic apparatus” may thus also be called the “usage frequency of the electronic apparatus”. The detector 32 transmits information (i.e., signals) representing the detected frequency of movement of the electronic apparatus 2 to the memory 33.

The memory 33 is configured by a semiconductor memory component included in the MCU 55, for example. The memory 33 is a non-volatile memory, for example. Information representing the detected frequency of movement of the electronic apparatus 2 is stored in the memory 33. Further, information received from the external apparatus 25 via the wireless module 21 is stored in the memory 33. For example, information relating at least one of a user and an owner of the electronic apparatus 2 received from the external apparatus 25 is stored in the memory 33. “Information relating at least one of a user and an owner of the electronic apparatus” is information relating to at least one of a user of the electronic apparatus 2 and an owner of the electronic apparatus 2, such as the name or point of contact of the user or the owner.

Further, product information for the electronic apparatus 2, retailer information, purchase information, and the like received from the external apparatus 25 may also be stored in the memory 33. “Product information for the electronic apparatus” is information relating to the electronic apparatus 2, such as product specifications or a product manual for the electronic apparatus 2, introduction of functions, shape or type (e.g., color variation), in to products from the same maker, price, ways to order, ways to request repairs, and the like. “Retailer information for the electric apparatus” is information on a retail outlet where the electronic apparatus 2 is purchased or information on the manufacturer of the electronic apparatus 2. Further, “purchase information” is information relating to, for example, the purchase price of the electronic apparatus 2 or a product combination.

Further, “electronic apparatus storage location information” received from the external apparatus 25 may also be stored in the memory 33. “Electronic apparatus storage location information” is information relating to a storage location of the electronic apparatus 2, that is, information indicating where the electronic apparatus 2 is stored.

The controller (e.g., control circuit) 34 is configured by a part of circuitry that is included in the MCU 55, for example. The controller 34 controls overall operation of the wireless device 1. For example, the controller 34 controls operations of the detector 32, the memory 33, the wireless module 21, and the like. The controller 34 stores information received from the external apparatus 24 through the wireless module 21 in the memory 33, in accordance with a signal (e.g., control signal) from the external apparatus 25. Further, the controller 34 transmits the information stored in the memory 33 to the external apparatus 25 through the wireless module 21 in accordance with a signal (e.g., control signal) from the external apparatus 25. That is, the controller 34 reads out information stored in the memory 33 by controlling the memory 33. The controller 34 transmits the information read out from the memory 33 to the wireless module 21. The controller 34 transmits the information which is transmitted to the wireless module 21 to the external apparatus 25 as an electromagnetic wave by controlling the wireless module 21.

The wireless module 21 refers to a module configured to at least transmit one or more signals. The module can be implemented by hardware. The wireless module 21 includes, but not limited to, circuitry and at least an antenna. For example, the wireless module 21 may include any additional structural element in addition to the circuitry and the at least one antenna. The circuity may be electrically coupled to the at least one antenna. The circuity may include, but not limited to, a wireless circuit 41 in FIG. 3. The at least one antenna may be, but is not limited to, an antenna 42 in FIG. 3. The wireless circuit 41 may he connected to the antenna 42.

The wireless circuit 41 converts signals representing information from the memory 33 or from the detector 32 into signals capable of being output from the antenna 42 based on control by the controller 34. The wireless circuit 41 of the present embodiment is a wireless circuit conforming to the standards of, for example, Bluetooth (trademark) (e.g., Bluetooth Low Energy (BLE)). Here, the wireless circuit 41 may also conform to communication standards utilized by Zigbee (trademark), Near Field Communication (NFC), or the 920 MHz band, for example.

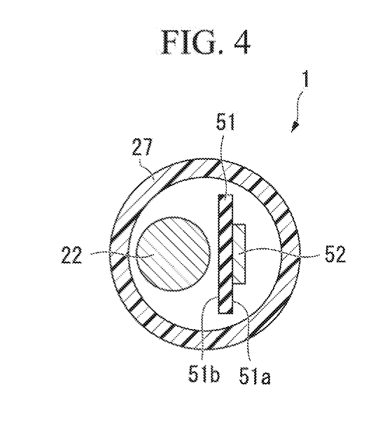

The at least one antenna refers to a transducer configured to transmit or receive an electromagnetic wave or electromagnetic waves. The antenna may be the antenna 42 which is electrically connected to the wireless circuit 41. Alternatively, the antenna 42 may be a chip antenna, or may be a pattern of conductor on a surface of a circuit board 51(See FIG. 4). The antenna 42 transmits signals received from the wireless circuit 41 to the external apparatus 25 as an electromagnetic wave (e.g., a wireless radio wave)

The wireless module 21 of the present embodiment transmits information obtained from output of the sensor 31 to the external apparatus 25. Here, the “information obtained from output of the sensor” may be measurement values included in output from the sensor 31, and may be information generated by performing computations or judgment defined in advance on the measurement values. In other words, the wireless module 21 is configured to transmit, to the external apparatus 25, at least one of an output signal from the sensor 31 and a signal which is generated based on the output signal from the sensor 31. In the present embodiment, as an example of “information obtained from output of the sensor”, the wireless module 21 sends information relating to frequency of movement of the electronic apparatus 2 to the external apparatus 25.

Further, the wireless module 21 transmits different types of information stored in the memory 33 to the external apparatus 25 based on control by the controller 34. In the present embodiment, the wireless module 25 transmits information for the electronic apparatus 2 stored in the memory 33 (such as information relating to at least one of the user or the owner, product information, retailer information, purchase information, and storage location information, and the like) to the external apparatus 25.

Further, the wireless module 21 of the present embodiment has a Beacon function utilizing BLE (e.g., iBeacon (trademark)). That is, the wireless module 21 transmits an electromagnetic wave (e.g., a radio wave) which is used to cause the external apparatus 25 to measure the intensity of the electromagnetic wave to detect a distance from the external apparatus 25 to the wireless device 21.

Further, in the present embodiment, identification information (such as an identification ID) may be assigned to the wireless module 21. The identification information is an example of “identifier”. The identification information is one example of identification information capable of identifying, from another apparatus, the electronic apparatus 2 in which the wireless device 1 is disposed. The wireless module 21 transmits the identification information of the wireless module 21 to the external apparatus 25 based on control by the controller 34. When the wireless module 21 does not have identification information, or when necessary, identification information (e.g., an identification ID) may also be assigned to at least one of the wireless device 1 and the electronic apparatus 2. In this case, the wireless module 21 may also transmit identification information assigned to at least one of the wireless device 1 and the electronic apparatus 2 to the external apparatus 25 as a substitute for the identification information of the wireless module 21, or in addition to the identification information of the wireless module 21. The identification information assigned to the wireless device 1 or to the electronic apparatus 2 may be stored in the memory 33, for example. The identification information assigned to the wireless device 1 or to the electronic apparatus 2 is another example of identification information (i.e., identifier) capable of identifying the electronic apparatus 2 in which the wireless device 1 is disposed, from another electronic apparatus.

The battery 22 and the electric power components e.g., electric power circuit components) 35, 36, and 37 are described below.

The battery 22 supplies electric powers to the detector 32, the memory 33, the controller 34, and the wireless circuit 41 through the electric power component (LDO) 35. Further, the battery 22 supplies electric power to the electric apparatus 2 (e.g., the electronic component 11 of the electric apparatus 2) through the electric power component (DC/DC converter) 36. The battery 22 may be a primary battery or a secondary battery. In the present embodiment, the battery 22 is a lithium ion secondary battery.

The electric power components 35, 36, and 37 include the low dropout (LDO) linear regulator 35, the DC/DC converter 36, and the charging connector 37.

The LDO 35 is electrically connected to the battery 22, and also to the sensor 31, the detector 32, the memory 33, the controller 34, and the wireless circuit 41. The LDO 35 supplies electric powers to the components 31, 32, 33, 34, and 41 using electric power supplied from the battery 22 in a circuit having a small difference between input voltage and output voltage.

The DC/DC converter 36 is electrically connected to the battery 22, and also to the electronic apparatus 2. The DC/DC converter 36 supplies electric power to the electronic apparatus 2 using the electric power supplied from the battery 22.

The charging connector 37 is an example of a “power electric receiver” and a “connector to be used for charging”. The charging connector 37 is electrically connected to the battery through a charging IC not shown in the figures. The charging connector 37 is electrically connected to an external charging device 45, and receives electric power, which is used to charge the battery 22, from the charging device 45.

Returning to FIG. 2, an example of an internal configuration of the wireless device 1 is described next.

As illustrated in (b) of FIG. 2, the wireless device 1 has a circuit board 51, a chip component 52, the antenna 42, the battery 22, the LDO 35, the DC/DC converter 36, and the charging connector 37.

The circuit board (i.e., board) 51 is formed in a rectangular plate shape. The circuit board 51 is housed in the case 27. The circuit board 51 has a first surface 51a, and a second surface 51b opposite to the first surface 51a (refer to FIG. 4). The chip component 52, the antenna 42, the LDO 35, the DC/DC converter 36, and the charging connector 37 are mounted together on the first surface 51a of the circuit board 51 and electrically connected to the circuit board 51. The circuit board 51 is electrically connected to the positive electrode terminal 28a and to the negative electrode terminal 28 of a ground potential.

The chip component (e.g., semiconductor component) 52 includes the sensor 31, the MCU 55, and the wireless circuit 41 described above. The chip component 52 is a component in which the sensor 31, the MCU 55, and the wireless circuit 41 are sealed together by a molding resin 57. Further, the MCU 55 is a semiconductor component including the detector 32, the controller 34, and the memory 33.

The battery 22 is accommodated in the case 27. The battery 22 has a positive electrode 22a and a negative electrode 22b. The positive electrode 22a of the battery 22 is electrically connected to the circuit board 51. More specifically, the positive electrode 22a of the battery electrically connected to the positive electrode terminal 28a of the wireless device 1 through the circuit board 51 and the DC/DC converter 36. On the other hand, the negative electrode 22b of the battery 22 is electrically connected to the negative electrode terminal 28b of the wireless device 1. More specifically, the negative electrode 22b of the battery 22 is electrically connected to ground through the negative electrode terminal 28b of the wireless device 1. For example, the battery 22 supplies a voltage of 3.0 V to 4.2 V.

The LDO 35 is disposed between the positive electrode 22a of the battery 22 and the chip component 52. The LDO 35 is electrically connected to the positive electrode 22a of the battery 22 and the chip component 52. For example, the LDO 35 steps down a voltage supplied from the battery 22 to 2.4 V and supplies that voltage to the chip component 52.

The DC/DC converter 36 is disposed between the positive electrode 22a of the battery 22 and the positive electrode terminal 28a of the wireless device 1. The DC/DC converter 36 is electrically connected to the positive electrode 22a of the battery 22 and to the positive electrode terminal 28a of the wireless device 1. For example, the DC/DC converter 36 steps down a voltage supplied from the battery 22 to 1.5 V and supplies that voltage to the electronic apparatus 2.

The charging connector 37 can be exposed to the outside of the wireless device 1 through an opening 27a of the case 27, for example. By inserting a connection terminal of a charging device 45 into the opening 27a, the charging device 45 is connected to the charging connector 37. Here, the circuit board 51 may also include a wireless electric power receiver (e.g.. electricity receiving coil) 37A as a substitute to the charging connector 37. The electric power receiver 37A receives electric power which is used in charging the battery 22 by wireless electricity supply from the external charging device 45. The electric power receiver 37A is another example of a “power electric receiver”.

FIG. 4 is a cross-sectional diagram of the wireless device 1 illustrated in FIG. 2 taken along a line segment F4-F4.

As illustrated in FIG. 4, the circuit board Si and the battery 22 are overlapped in the plane direction of the circuit board 51. The battery faces the second surface 51b of the circuit board 51, for example. That is, the circuit board 51 is located between the battery 22 and the chip component 52. According to this configuration the circuit board 51 and the battery 22, each relatively large, can be accommodated within the case 27.

Several examples of using the wireless device 1 are described below.

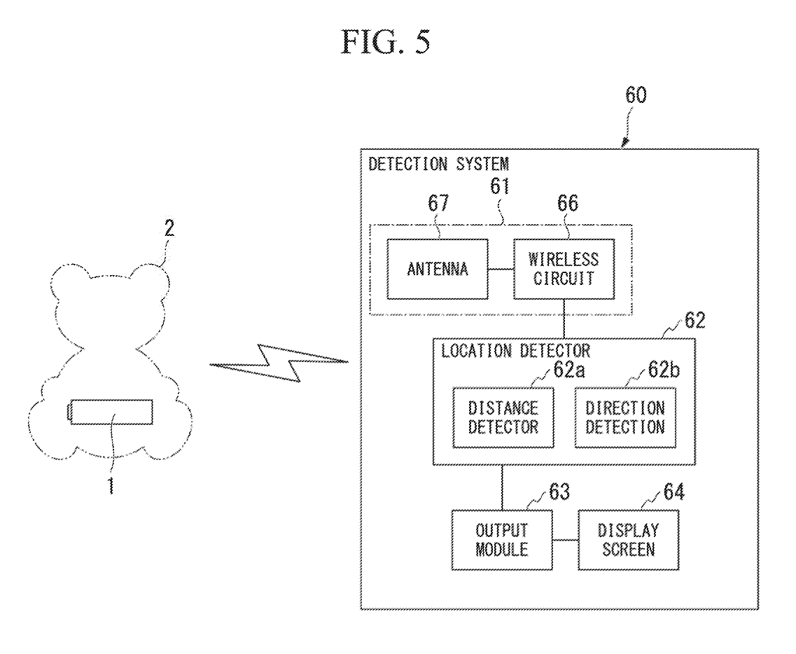

FIG. 5 illustrates a first usage example of the wireless device 1 and the external apparatus 25. In this usage example, the electronic apparatus 2 is assumed to be owned by an owner who also owns an electronic apparatus like a smart phone or a tablet terminal, for example. The external apparatus 25 has a detection system (i.e., information processing system) 60 that detects information relating to the electronic apparatus 2 (e.g., position information for the electronic apparatus 2). The detection system 60 has a wireless module 61, a location detector 62, an output module 63, and a display screen 64, for example.

The wireless module 61 includes a wireless circuit 66 and an antenna 67. The wireless circuit 66 conforms to a standard similar to that of the wireless circuit 41 of the wireless device 1. For example, the wireless module 61 conforms to Bluetooth (for example, BLE). That is, the wireless module 61 is capable of transmitting and receiving information with the wireless module 21 of the wireless device 1.

The location detector 62 includes a distance detector 62a and a direction detector 62b.

The distance detector 62a detects a distance from the external apparatus 25 to the wireless device 1 based on the intensity of the electromagnetic wave (e.g., the intensity of the radio wave) that the external apparatus 25 receives from the wireless device 1.

The direction detector 62b detects the direction of the wireless device 1 with respect to the external apparatus 25 based on the intensity of the electromagnetic wave the intensity of the radio wave) that the external apparatus 25 receives from the wireless device 1. That is, the direction detector 62b detects the direction of the wireless device 1 with respect to the external apparatus 25 by comparing intensities of the electromagnetic wave (e.g., the intensities of the radio wave) in multiple directions.

The position detector 62 detects the position of the wireless device 1 with respect to the external apparatus 25 based on the distance from the external equipment 25 to the wireless device 1, and on the direction f the wireless device 1 with respect to the external apparatus 25. The location detector 62 transmits information regarding the detected position of the wireless device 1 to the output module 63.

The output module 63 displays information received from the location detector 62 on the display screen 64. The user can thus know the position of the wireless device 1.

Further, by transmitting a signal or signals (e.g., a control signal or signals) to the wireless device 1, the detection system 60 receives information stored in the memory 33 of the wireless device I from the wireless device 1. The output module 63 of the detection system 60 displays the information received from the wireless device 1 on the display screen 64. A user can thus confirm, for example, information relating at least one of the user and the owner, product information, retailer information, purchase information, storage location information, and the like, for the electronic apparatus 2.

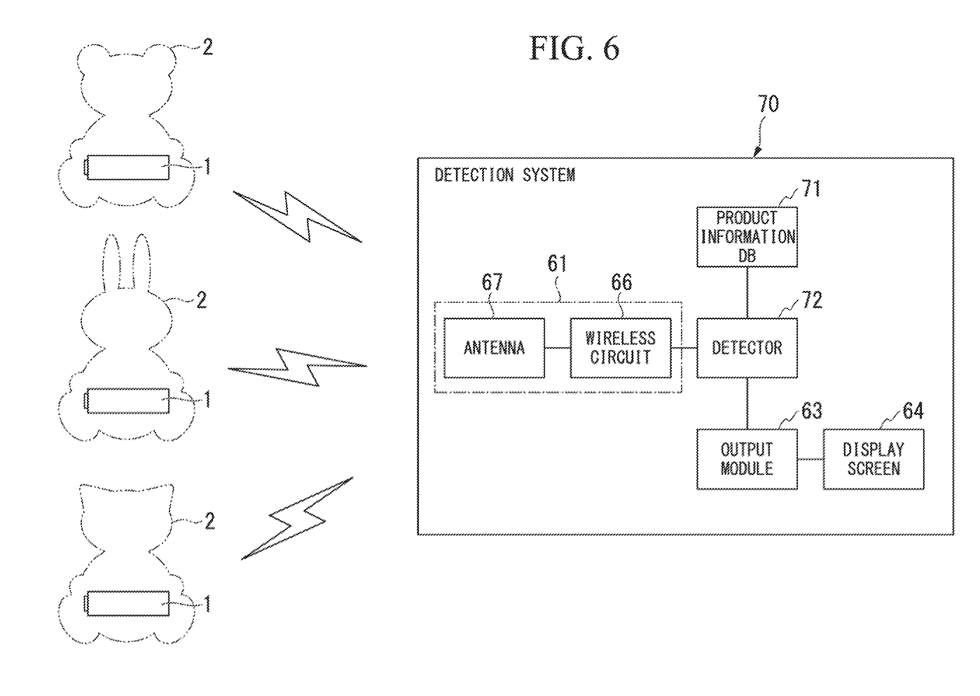

A second usage example for the wireless device 1 is described below. FIG. 6 illustrates the wireless device 1 and the external apparatus 25 of the second usage example. In this usage example, the electronic apparatus 2 is assumed to be located at a retail store.

In this usage example, the external apparatus 25 is an information processing device located in a retail store where the electronic apparatus 2 is sold, for example. The external apparatus 25 has a detection system (i.e., information processing system) 70 that detects information relating to multiple electronic apparatuses 2 (e.g., a plurality of the electronic apparatuses 2). The detection system 70 includes the wireless module 61, product information DB 71, a detector 72, the output module 63, and the display screen 64, for example. Here, the wireless module 61 may be identical in configuration and function as the wireless module 61 in the first usage example, and a detailed explanation is thus omitted. The wireless module 61 of this usage example performs wireless communication with multiple wireless devices 1, transmitting and receiving information between the multiple wireless devices 1.

Information relating to the multiple electronic apparatuses 2 and identification information (i.e., identifier) of the multiple electronic apparatuses 2 are stored in the product information database (product information DB) 71. “Information relating to multiple electronic apparatuses” is information used in marketing, such as product information of each electronic apparatus 2 (e.g., specifications, price, and manufacturer). “Identification information of multiple electronic apparatuses” is the identification information assigned to the wireless module 21 of the wireless device 1 mounted in each electronic apparatus 2, and may also mean the identification information assigned to each wireless device 1 or to each electronic apparatus 2.

The detector 72 receives information regarding frequency of movement of each electronic apparatus 2 from the wireless device 1, through the wireless module 61. “Frequency of movement of each electronic apparatus” may be the number of times that the electronic apparatus 2 is actually picked up by hand or touched in a retail store. The detector 72 detects the popularity (i.e., customer attractiveness) of the multiple electronic apparatuses 2 based on information relating to the frequency of movement of each electronic apparatus 2 and on information stored in the product information DB 71. The detector 72 transmits information relating to popularity of the detected electronic apparatus 2 to the output module 63. The output module 63 displays information received from the detector 72 on the display screen 64.

Here, the product information DB 71, the detector 72, and the output module 63 in the detection system 70 may be implemented by using a device that differs from the external apparatus 25 (e.g., a server connected to the external apparatus 25 by a network).

The wireless device 1 configured as described above may easily add wireless communication function to the electronic apparatus 2, which does not have a wireless communication function.

That is, when a card type or USB type wireless device, for example, is installed in an electronic apparatus, the electronic apparatus requires a special interface capable of installing the wireless device. It may be difficult to additionally install a wireless device in an electronic apparatus that does not have an interface like those described above. Further, if a wireless device is installed on an external surface of an electronic apparatus, the wireless device may fall off, the electronic apparatus becomes less visually attractive, or the like.

The wireless device 1 of the present embodiment includes the case 27 and the wireless module 21 in the case 27. The case 27 is configured to be accommodated in the battery housing 13 of the electronic apparatus 2.

According to such a configuration, the wireless device 1 may easily be installed in the electronic apparatus 2, which does not have a special interface. Further, even with the wireless device 1 is installed, the wireless device 1 will not fall off and the electronic apparatus 2 will not become less visually attractive. Further it is also not necessary to change the current shape of the electronic apparatus 2. The wireless communication function may thus be easily added to electronic apparatuses 2 current on the market.

In the present embodiment, the wireless device 1 is configured to be disposed between the positive terminal 16a and the negative terminal 16b, and to be supported by the positive terminal 16a and by the negative terminal 16b.

According to such a configuration, a special mounting structure is not required in order to support the wireless device 1. The wireless communication function may thus even more easily be provided to the electronic apparatus 2 by using the wireless device 1, which is capable of being added to the electronic apparatus 2.

In the present embodiment, the wireless device 1 includes the battery 22 in the case 27. The battery 27 supplies electric power to the wireless module 21. According to such a configuration, an external electric power source is not required for the wireless module 21. The wireless communication function may thus even more easily be provided to the electronic apparatus 2 by using the wireless device 1, which is capable of being added to the electronic apparatus 2.

In the present embodiment, the case 27 has an external shape substantially the same as the external shape of the standardized normal battery 15. The case 27 includes the positive electrode terminal 28a that is contactable to the positive terminal 16a of the battery housing 13, and the negative electrode terminal 28b that is contactable to the negative terminal 16b of the battery housing 13. The battery 22 is electrically connected to the positive electrode terminal 28a and to the negative electrode terminal 28b. The battery 22 supplies electric power to the electronic apparatus 2.

According to such a configuration, the wireless device 1 has the same electric power function as the normal battery 15 for the electronic apparatus 2. That is, even when the wireless device 1 is disposed in the battery housing 13, the electronic apparatus 2 can receive normal electric power, and can operate. The wireless communication function may thus even more easily be provided to the electronic apparatus 2 by using the wireless device 1, which is capable of being added to the electronic apparatus 2.

In the present embodiment, the wireless module 21 transmits an identifier, to the external apparatus 25, and the identifier is used for identifying the electronic apparatus 2 from another electronic apparatus. According to such a configuration, the electronic apparatus 2 in which the wireless device 1 is installed can be distinguished based on the identifier from the wireless module 21. Therefore, a variety of information can be provided to a user of the external apparatus 25.

In the present embodiment, the wireless module 21 transmits an electromagnetic wave (e.g., a radio wave) which is used to cause the external apparatus 25 to measure the intensity of the electromagnetic wave (e.g., a radio wave) to detect the distance from external apparatus 25 to the wireless device 1. In other words, a Beacon function can be added to the electronic apparatus 2, which does not have a Beacon function, by using the wireless module 21. According to such a configuration, the location of the electronic apparatus 2 may be detected utilizing the external apparatus 25. Therefore, it is possible to easily detect the location of the electronic apparatus 2 when a person does not know the location of the electronic apparatus 2.

In the present embodiment, the wireless device 1 includes the sensor 31 in the case 27. The sensor 21 transmits information obtained from output of the sensor 31 to the external apparatus 25. In other words, the sensor 21 is configured to transmit, to the external apparatus 25, at least one of an output signal from the sensor 21 and a signal which is generated based on the output signal from the sensor 21. According to such a configuration, a variety of information detected by the sensor 31 may be provided to a user of the external apparatus 25.

In the present embodiment, the sensor 31 includes the acceleration sensor 31a According to such a configuration, movement of the electronic apparatus 2 (e.g., being dropped), and forces, impacts, and the like acting on the electronic apparatus 2 can be measured.

In the present embodiment, the wireless device 1 includes the detector 32 that detects frequency of movement of the electronic apparatus 2 based on output from the acceleration sensor 31a. The wireless module 21 transmits, to the external apparatus 25, a signal representing the frequency of movement detected by the detector 32. According to such a configuration, a user of the external apparatus 2D canreceive information relating to the frequency of movement of the electronic apparatus 2. The information relating to the frequency of movement of the electronic apparatus 2 may be utilized as information for assessing the usage state and usage frequency of the electronic apparatus 2, as well as the popularity of the electronic apparatus 2. According to such a configuration, it is possible to provide high convenient wireless device 1.

In the present embodiment, the wireless device I includes the memory 33 in the case 27. The wireless module 21 transmits information stored in the memory 33 to the external apparatus 25. According to such a configuration, a user or an owner of the external apparatus 25 can store a variety of information in the memory 33 of the wireless device 1 through, for example, the external apparatus 25, and can also receive the information when necessary in the external apparatus 25 from the wireless device 1. It is thus possible to provide an additionally user-friendly wireless device 1.

In the present embodiment, product information of the electronic apparatus 2 is stored in the memory 33. The wireless module 21 transmits the product information to the external apparatus 25. According to such a configuration, a user or an owner of external apparatus 25 can receive electronic apparatus product information when necessary.

In the present embodiment, information relating to at least one of a user and an owner of the electronic apparatus 2 is stored in the memory 33. The wireless module 21 transmits the information relating to the at least one of the user and the owner of the electronic apparatus 2 to the external apparatus 25. According to such a configuration, a user of the external apparatus 25 can receive information relating to the at least one of the user and the owner for the electronic apparatus 2 when necessary. Mix-ups between electronic apparatuses 2 and the like can thus be avoided.

In the present embodiment, information relating to a storage location for the electronic apparatus 2 is stored in the memory 33. The wireless module 21 transmits the information relating to the storage location of the electronic apparatus 2 to the external apparatus 25. According to such a configuration, a user of the external apparatus 25 can receive information relating to the storage location of the electronic apparatus 2 when necessary. A user can thus easily recall the storage location of the electronic apparatus 2.

In the present embodiment, information relating to a retailer of the electronic apparatus 2 is stored in the memory 33. The wireless module 21 transmits the information relating to the retailer of the electronic apparatus 2 to the external apparatus 25. According to such a configuration, a user of the external apparatus 25 can receive information on the retailer of the electronic apparatus 2 when necessary. A user can thus easily recall a prior retailer when replacing the electronic apparatus 2. Further, it becomes simple to get ahold of parts that have failed.

In the present embodiment, the wireless device I includes the circuit board 51 in the case 27. Further, the battery 22 is a secondary battery. The circuit board 51 includes an electric power receiver (e.g., the charging connector 37 or the electric power receiver 37A) that receives electric power for charging the secondary battery from the external charging device 45. According to such a configuration, a wireless device 1 capable of being used over a long period of time, due to use of a secondary battery, may be provided.

Several modifications of the embodiment described above are described below. Here, in the modifications, configurations other than those explained below are similar to the configurations of the embodiment described above.

### FIRST MODIFICATION EXAMPLE

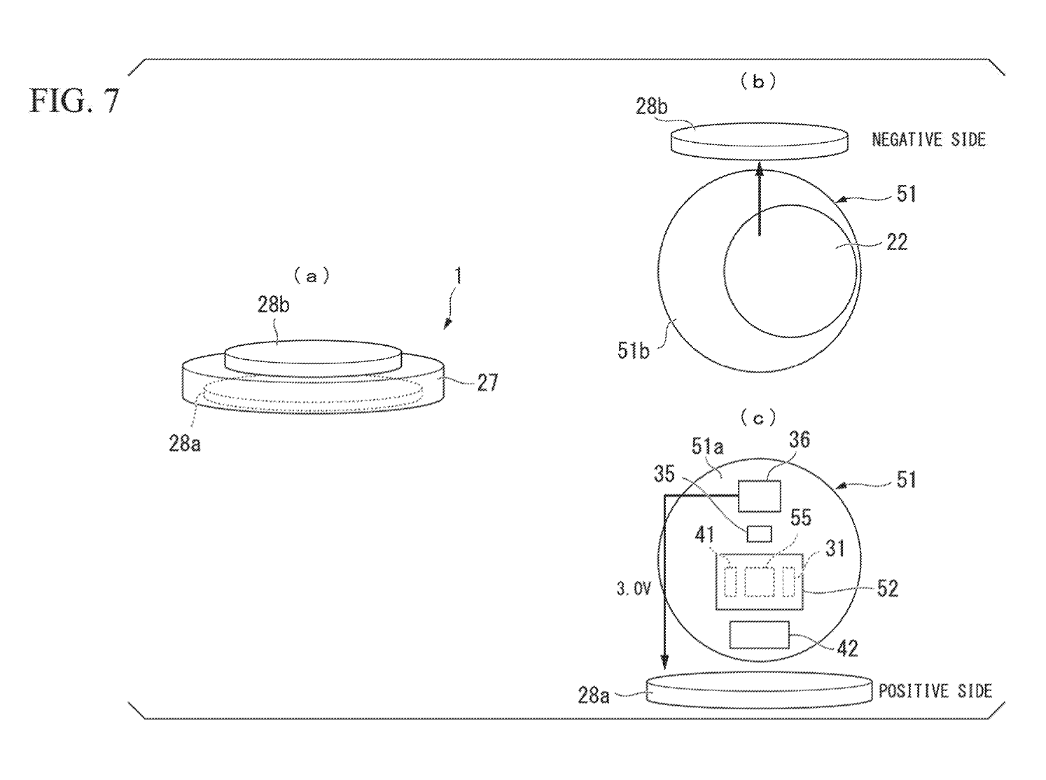

FIG. 7 illustrates the wireless device 1 according to a first modification example. (a) of FIG. 7 illustrates an external view of the wireless device 1. (b) of FIG. 7 illustrates one surface of the circuit board 51. (c) of FIG. 7 illustrates another surface of the circuit board 51.

As illustrated in FIG. 7, the wireless device 1 of the first modification example has an external shape substantially the same as a button battery. For example, the wireless device 1 has an external shape substantially the same as a CR2032 standard battery.

The circuit board 51 of the present modification example is formed in a circular plate shape. The circuit board Si includes a first surface 51a, and a second surface 51b located on a side opposite to the first surface 51a. The chip component 52, the antenna 42, the LDO 35, and the DC/DC converter buck-boost DC/DC converter) 36 are mounted on the first surface 51a of the circuit board 51.

The battery 22 overlaps the circuit board 51 in the plane direction of the circuit board 51. For example, the battery 22 is attached to the second surface 51b of the circuit board 51. The battery 22 of the present modification example is a primary battery, for example. The battery 22 is a CRI 612 battery, for example.

Even according to the present modification example, wireless communication functionality may easily be added to the electronic apparatus 2, which does not have wireless communication functionality, similar to the embodiment described above.

### SECOND MODIFICATION EXAMPLE

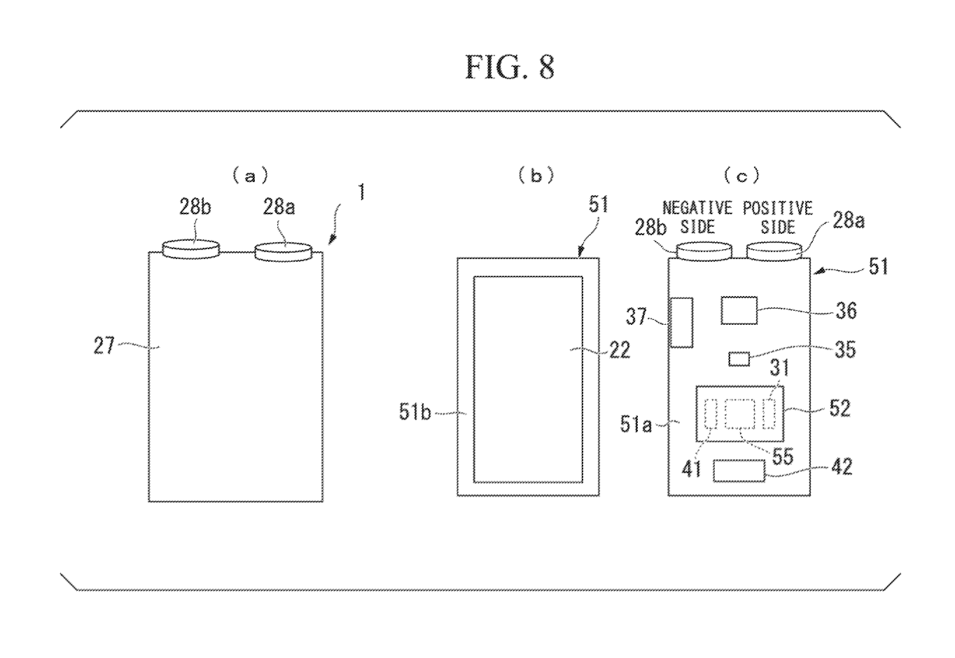

FIG. 8 illustrates the wireless device 1 according to a second modification example. (a) of FIG. 8 illustrates an external view of the wireless device 1. (b) of FIG. 8 illustrates a surface of the circuit board 51. (c) of FIG. 8 illustrates another surface of the circuit board 51.

As illustrated in FIG. 8, the wireless device 1 of the present modification example has a shape substantially the same as a 9V rectangular battery.

The circuit board 51 in the present modification example is formed in a rectangular plate shape. The chip component 52, the antenna 42, the LDO 35, and the DC/DC converter (e.g., boost DC/DC converter) 36 are mounted on the first surface 51a of the circuit board 51. The DC/DC converter 36 boosts the voltage output by the battery (e.g., 3.0 V to 4.2 V) to 9V and supplies the boosted voltage to the electronic apparatus 2.

The battery 22 overlaps the circuit board 51 in the plane direction of the circuit board 51. For example, the battery is attached to the second surface 51b of the circuit board 51. The battery 22 in the present modification example is rectangular shape, similar to the circuit board 51.

Even according to the present modification example, wireless communication functionality may easily be added to the electronic apparatus 2, which does not have wireless communication functionality, similar to the embodiment described above.

### THIRD MODIFICATION EXAMPLE

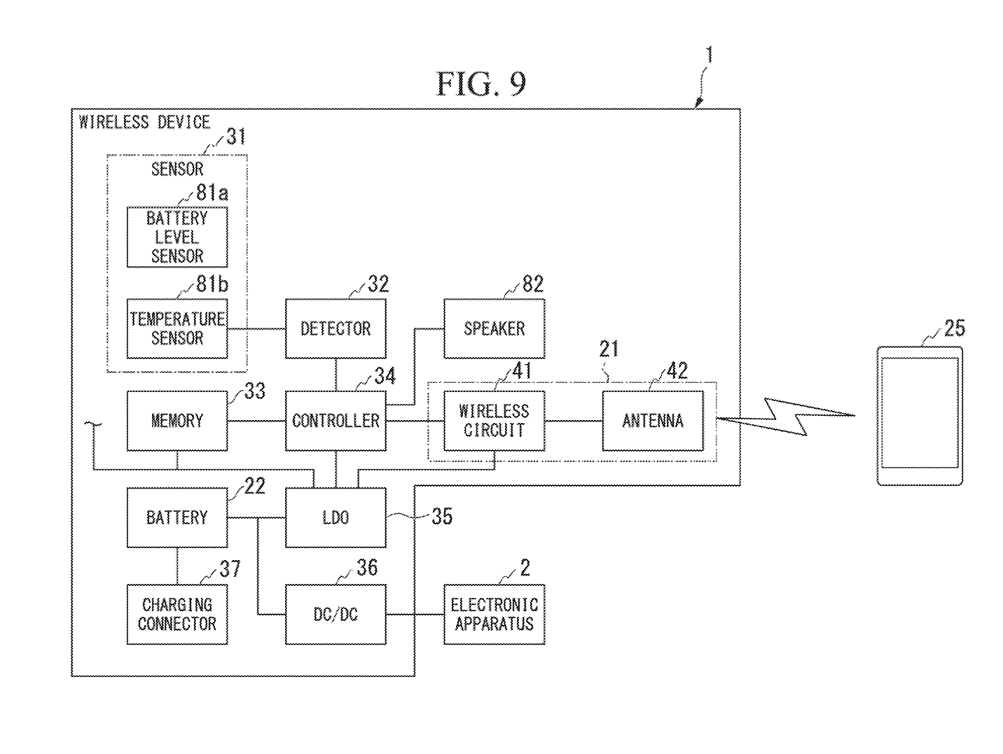

FIG. 9 illustrates the wireless device 1 according to a third modification example. As illustrated in FIG. 9, the sensor 31 of this modification example includes a battery level sensor 81a and a temperature sensor 81b.

The battery level sensor 81a is a charge level sensor, for example, that detects the charge level of the battery 22. The battery level sensor 81a transmits information relating to the detected battery level to the detector 32. The detector 32 compares the battery level detected by the battery level sensor 81a with a standard value set in advance, for example. When the battery level has fallen below the standard value set in advance, the controller 34 transmits information indicating that the battery level is low to the external apparatus 25 through the wireless module 21. Here, the controller 34 may also transmit information relating to the battery level (e.g., the actual battery level) to the external apparatus 25.

The temperature sensor 81b detects the temperature of the battery 22, for example. The temperature sensor 81b transmits information relating to the detected temperature of the battery 22 to the detector 32. The detector 32 compares the temperature of the battery 22 with a standard value set in advance, for example. When the temperature of the battery 22 exceeds the standard value set in advance, the controller 34 transmits information indicating that the temperature of the battery 22 is high to the external apparatus 25 through the wireless module 21. Here, the controller may also send information relating to the temperature of the battery 22 (e.g., the actual temperature) to the external apparatus 25.

Further, the wireless device 1 of the present modification example has a speaker 82. The controller 34 drives the speaker 82 to generate sound in accordance with a signal (e.g., control signal) from the external apparatus 25. For example, when a control signal for generating a Beacon radio wave is received from the external apparatus 25, the controller 34 operates the speaker 82 in accordance with emission of the Beacon radio wave. A user of the external apparatus 25 may thus more easily find the wireless device 1.

According to such a configuration, a user of the external apparatus 25 can receive information relating to the level and temperature of the battery 22. Further, a user of the external apparatus 25 can search for the wireless device 1 utilizing the sound from the speaker 82 in addition to a Beacon radio wave. An additionally higher user-friendly wireless device 1 may thus be provided.

### FOURTH MODIFICATION EXAMPLE

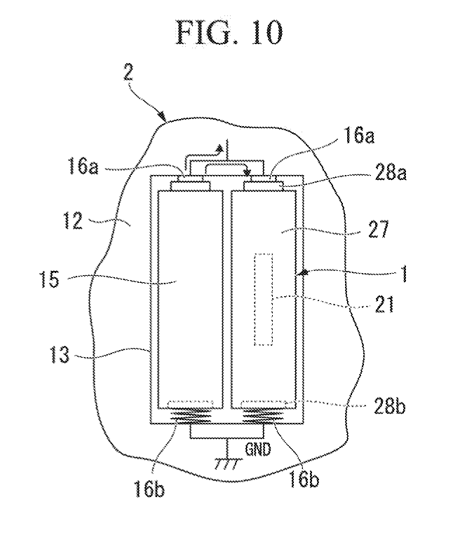

FIG. 10 illustrates the wireless device 1 according to a fourth modification example. As illustrated in FIG. 10, the wireless device 1 of the fourth modification example is accommodated in the batter housing 13, and the battery housing 13 is capable of accommodating a plurality of normal batteries 15. More specifically, the battery housing 13 is capable of accommodating, for example, a plurality of normal batteries 15 in parallel electrically. At least one normal battery 15 is attached to the battery housing 13 here. The normal battery 15 supplies electric power to the electronic apparatus 2.

The wireless device 1 of the present modification example does not have the battery 22. The wireless device 1 operates by receiving electric power from the normal battery 15 in the battery housing 13. That is, the circuit board 51 and the chip component 52 (i.e., the wireless module 21), and the like, of the wireless device 1 operate by receiving electric power from the normal battery 15.

Even according to such a modification, the wireless communication function may easily be added to the electronic apparatus 2, which does not have wireless communication functionality, similar to the embodiment described above. Further, according to the present modification example, the structure of the wireless device 1 may be made simple, and reductions in cost of the wireless device 1 can thus be achieved.

A method of inputting information into and a method of updating information in the wireless device 1 is described next.

In order to surely prevent unintended rewriting of information, encryption key information or the like for indicating rewrite authority and conditions is provided in the wireless device 1 during manufacturing thereof.

FIG. II is a block diagram of a system configuration of the wireless device 1.

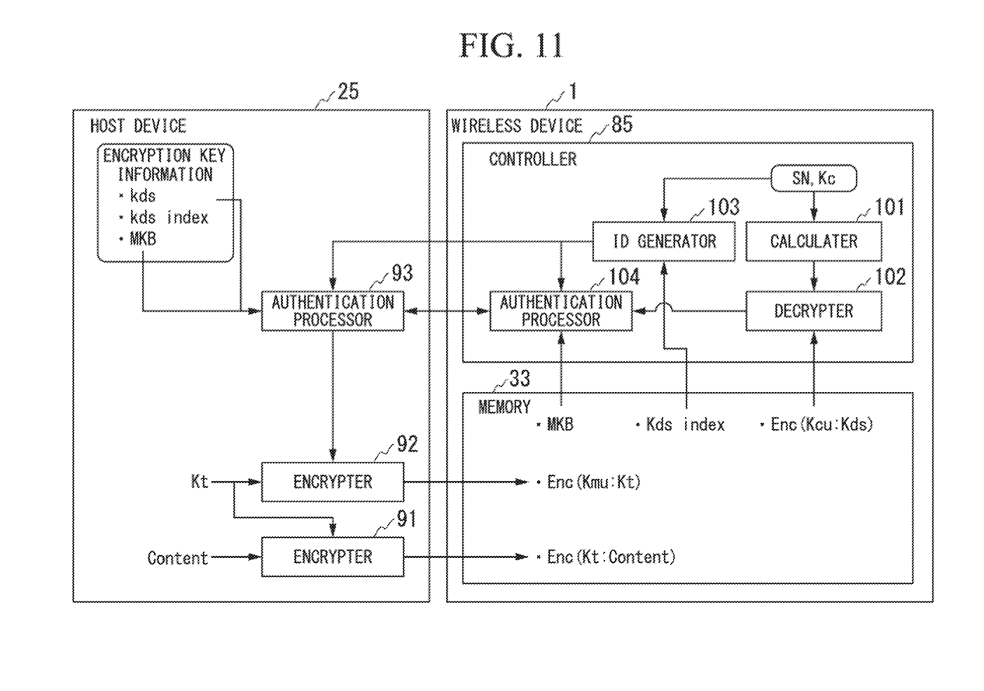

As illustrated in. FIG. 11, the wireless device 1 has the memory 33 in which information is stored, and a memory controller 85 that controls the memory 33. The memory controller 85 may be implemented by a part of the controller 34, for example, or may be provided separate to the controller 34. An authentication is such as SeeQValt (trademark) is provided in at least one of the memory 33 and the memory controller 85.

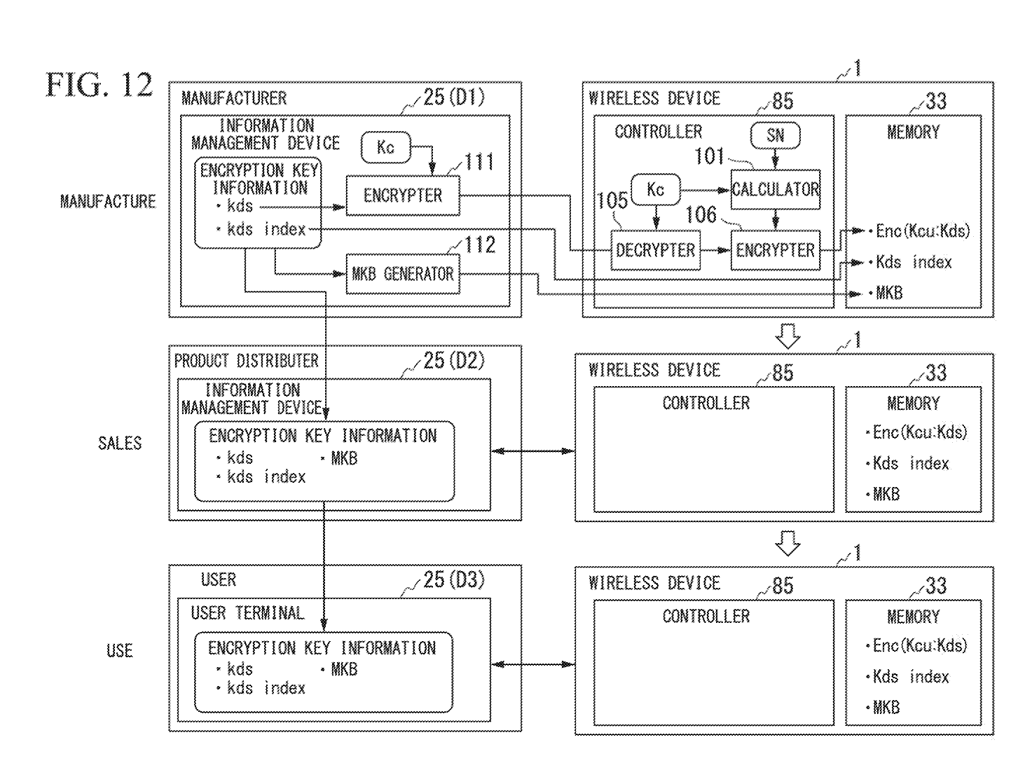

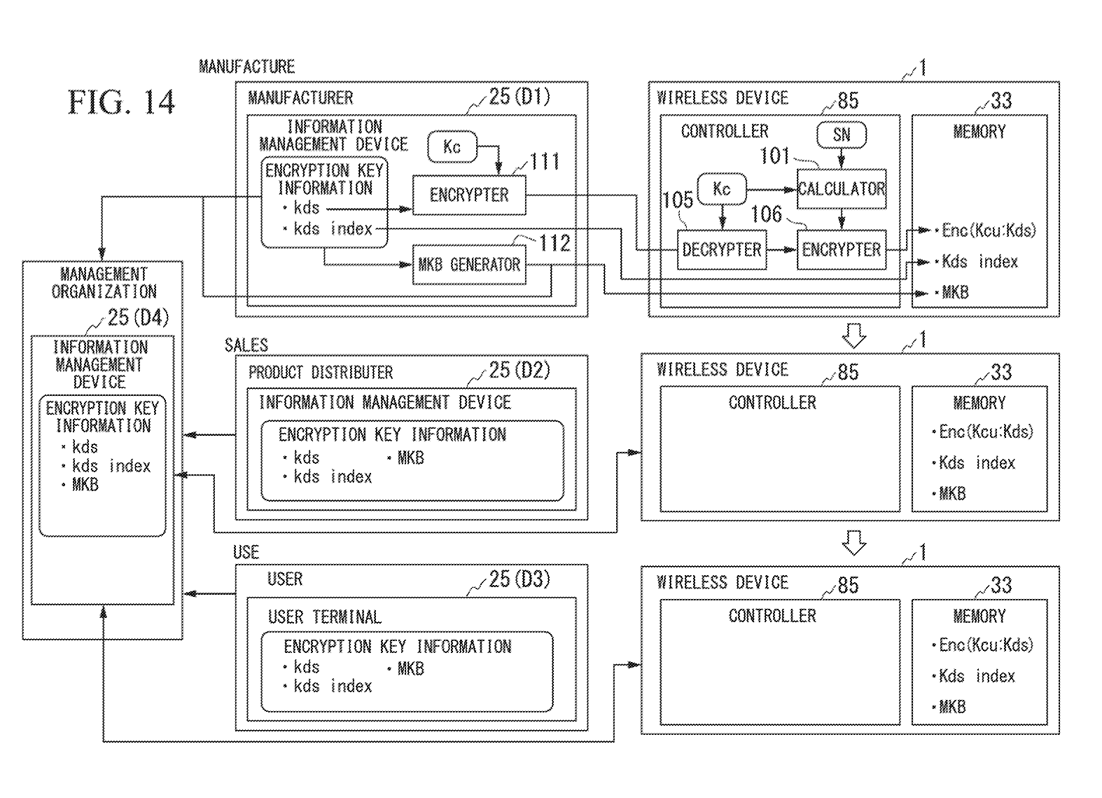

More specifically, the external apparatus 25, acting as a host device, transmits information by wireless communication to the memory 33 of the wireless device 1. Here, the external apparatus 25 as a host is an information management device used by a manufacturer during manufacture of the wireless device 1 or an information management device of a product distributor during product sales of the wireless device 11, and is a user terminal of a user during use of the wireless terminal 1 (refer to FIG. 12). Further, the external apparatus 25 as the host may also be an information management device for an external management organization during product sales and use of the wireless device 1 (refer to FIG. 14).

As FIG. 11 illustrates, a device key set Kds, a device key set index Kds index, and a media key block (MKB) may be stored in the external apparatus 25 as encryption key information, for example. The device key set Kds is a device key aggregate set in the external apparatus 2D as encryption keys. The device key set index Kds index is a reference number assigned to the device key set Kds, and uniquely identifies the device key set Kds, MKB is obtained by encrypting a media key Km, for encrypting. information (e.g., contents), using the device key set Kds.

Further, the external apparatus 25 has a first encrypter 91, a second encrypter d an authentication processor 93. The first encrypter 91 generates encrypted contents Enc(Kt:Content) through encryption of information (e.g., contents) by a title key Kt. The first encrypter 91 transmits the encrypted contents Enc(Kt:Content) to the memory 33 of the wireless device 1. The second encrypter 92 generates an encrypted title key Enc(Kmu:Kt) through encryption of a title key Kt by a media unique key Kmu. The second encrypter 92 transmits the encrypted title key Enc(Kmu:Kt) to the memory 33. Here, the media unique key Kmu is generated based on a media ID received from the wireless device 1. The authentication processor 93 decrypts MKB by using the device key set Kds, and obtains the media key Km. The authentication processor 93 runs authentication operations with respect to the wireless device 1 based on the media key Km and the media unique key Kmu. That is, the authentication processor 93 runs authentication operations with respect to the wireless device 1 based on the device key set Kds, MKB, and the media ID.

On the other hand, an encrypted device key set Enc(Kcu:Kds), the device key set index Kds index, and MKB are stored in the memory 33 of the wireless device 1. The encoded device key set Enc(Kcu:Kds) is obtained by encrypting the device key set Kds using a controller unique key Kcu, described below.

Further, a controller key Kc and a serial number SN are assigned to the memory controller 85 of the wireless device 1. Further, the memory controller 85 of the wireless device I has a calculator (e.g., secret calculator) 101, a decrypter 102, an ID generator 103, and an authentication processor 104.

The calculator 101 generates the controller unique key KCu based on the controller key Kc and the serial number SN. The controller unique key Kcu is unique data that differs for each memory controller 85.

The decrypter 102 obtains the device key set Kds by decrypting the encrypted device key set Enc(Kcu:Kds) using the controller unique key Kcu.

The ID generator 103 generates the media ID based on the serial number SN and the device key set index Kds index.

The authentication processor 104 obtains the media key Km by decrypting MKB using the device key set Kds. Further, the authentication processor 104 generates the media unique key Kmu based on the media ID. The authentication processor 104 runs authentication operations with respect to the external apparatus 25 based on the media key Km and the media unique key Kmu. That is, the authentication processor 104 runs authentication operations with respect to the external apparatus 25 based on the device key set Kds, MKB, and the media M.

FIG. 12 illustrates an example of a process for managing encrypted information of the wireless device 1.

Note that, in FIG. 12 to FIG. 14, each of a manufacturer information management device D1, a product distributor information management device D2, a user terminal of a user D3, and a management organization information management device D4 is an example of the external apparatus 25, and includes configurations substantially the same as the external apparatus 25 illustrated in FIG. 11.

Further, as illustrated in FIG. 12, the manufacturer information management device D1 includes an encrypter 111 and an MKB generator 112. A manufacturer of the wireless device 1 has information on the controller key Kc of the memory controller 85 mounted in the wireless device 1. The encrypter 111 generates the encrypted device key set Enc(Kc:Kds) by encrypting the device key set Kds using the controller key Kc. The encrypter 111 transmits the encrypted device key set Enc(Kc:Kds) to the controller 85 of the wireless device 1. On the other hand, the MKB generator 112 generates MKB based on the device key set Kds, the device key set index Kds index, and the media key Km. The MKB generator 112 transmits MIKE to the memory 33 of the wireless device 1.

As illustrated in FIG. 12, the memory controller 85 of the wireless device 1 includes a decrypter 105 and an encrypter 106. The decrypter 105 obtains the device key set Kds by decrypting the encrypted device key set Enc(Kc:Kds) using the controller key Kc. The encrypter 106 obtains the encrypted device key set Enc(Kcu:Kds) by encrypting the device key set Kds using the controller unique key Kcu. The encrypted device key set Enc(Kcu:Kds) is stored in the memory 33.

As illustrated in FIG. 12, when the wireless device 1 is to be sold, encryption key information including the device key set Kds, the device key set index Kds index, and MKB is given from a manufacturer to a product distributor. The product distributor information management device D2 can perform authentication of the wireless device 1, input information, and update information by using the encryption key information.

Further, when the wireless device 1 is to be used, the encryption key information is given from a product distributor to a user. The user terminal of a user D3 can perform authentication of the wireless device 1, input information, and update information by using the encryption key information.

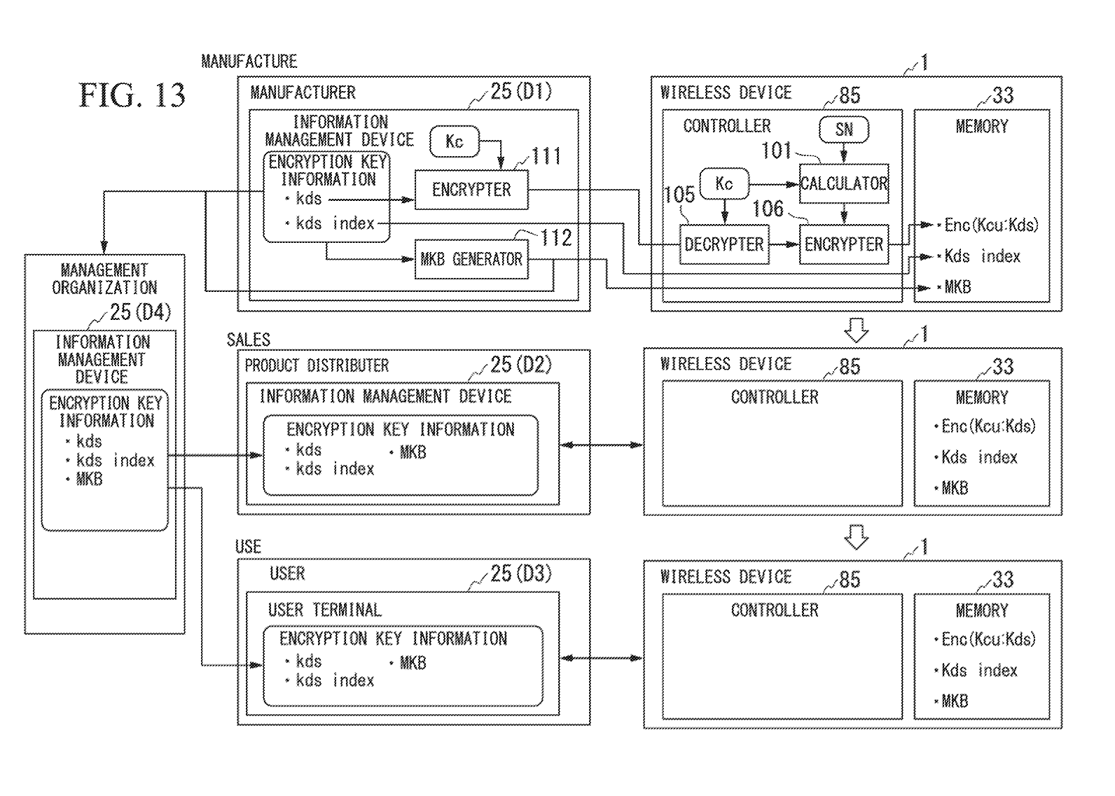

FIG. 13 illustrates a first modification example of the process of managing encrypted key information.

As illustrated in FIG. 13, the encrypted key information may also be provided from a manufacturer to an external management organization at the time of product shipment. In this case, the product distributor and the user receive the encryption key information from the management organization for product sales and use.

FIG. 14 illustrates a second modification of the process of managing encrypted key information.

As illustrated in FIG. 14, the encrypted key information may also be provided from a manufacturer to an external management organization at the time of product shipment. The management organization may also manage all of the encryption key information together. In this case, input of information to, and updates of information in, the wireless device 1 may only be performed via the management organization.

Note that management of processes such as authentication of, and information input to, the wireless device 1 is not limited to the examples described above. Management of processes such as authentication of, and information input to, the wireless device 1 may also be suitably performed using a variety of methods.

One embodiment and several modification examples are described above, but embodiments and modification examples are not limited to the ones described above. For example, the wireless device 1 may also have an external shape substantially the same as a normal battery 15 conforming to a standard other than those described above (e.g., a D cell battery or a C cell battery).

Further, processors that process information (the detector 32 and the controller 34 of the wireless device 1; the location detector 62, the output module 63, and the detector 72 of the detection systems 60 and 70; and the like) may also be implemented by a processor such as a CPU or the like running a program. The program may be stored in the memory 33 within the MCU 55, or in a memory included in the detection system 60 or the detection system 70. The processors described above may also be implemented by hardware such as LSI (large scale integration) or ASIC (application specific integrated circuit) including functions similar to a program run by a processor. The processors described above may also be implemented by a combination of hardware and a processor such as a CPU or the like running a program.

According to at least one embodiment explained above, a wireless device includes a case and a wireless module in the case. The case is configured to be accommodated in a battery housing of an electronic apparatus. According to such a configuration, a wireless communication function may easily be added to the electronic apparatus, which does not have a wireless communication function.

While certain embodiments have been described, these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A battery-shaped wireless device, comprising:
a housing having an exterior shape of a standardized battery;
a wireless module disposed in the housing and configured to generate a wireless signal; and
a control circuit configured to cause the wireless module to generate the wireless signal

2. The battery-shaped wireless device according to claim 1, wherein
the housing is formed of a material that permits the wireless signal to pass therethrough.

3. The battery-shaped wireless device according to claim 1, wherein
a distance to the battery-shaped wireless device is detectable by reception of the wireless signal.

4. The battery-shaped wireless device according to claim 1, further comprising:
a battery module disposed in the housing and configured to supply power to electric components in the housing, including the wireless module and the control circuit.

5. The battery-shaped wireless device according to claim 4, wherein
the wireless module and the control circuit are disposed on a substrate, and
the battery module faces a side of the substrate opposite to a side on which the wireless module and the control circuit are disposed.

6. The battery-shaped wireless device according to claim 5, wherein
the housing has a cylindrical shape, and the battery module extends along a length direction of the cylindrical shape.

7. The battery-shaped wireless device according to claim 4, further comprising:
a battery capacity sensor disposed in the housing, wherein
the control circuit is further configured to cause the wireless module to transmit data based on a detection result of the battery capacity sensor through the wireless signal.

8. The battery-shaped wireless device according to claim 4, further comprising:
a temperature sensor disposed in the housing, wherein
the control circuit is further configured to cause the wireless module to transmit data based on a detection result of the temperature sensor through the wireless signal.

9. The battery-shaped wireless device according to claim 4, further comprising:
a connector formed on the housing for connection to a charging cable, and
the battery module is rechargeable through power received through the connector.

10. The battery-shaped wireless device according to claim 1, further comprising:
a first terminal formed on the housing and configured to be connected to a positive terminal of a host device that houses the battery-shaped wireless device, and
a second terminal formed on the housing and configured to be connected to a negative terminal of the host device.

11. The battery-shaped wireless device according to claim 10, wherein
one of the first and second terminals is configured to receive power from a standardized battery housed in the host device together with the battery-shaped wireless device.

12. The battery-shaped wireless device according to claim 10, wherein
one of the first and second terminals is configured to output power from the battery module.

13. The battery-shaped wireless device according to claim 1, herein
a voltage level of the power output through said one of the first and second terminals is different from a voltage level of power supplied to the electric components in the housing.

14. The battery-shaped wireless device according to claim 1, further comprising:
an acceleration sensor disposed in the housing, wherein
the control circuit is further configured to cause the wireless module to transmit data based on a detection result of the acceleration sensor through the wireless signal.

15. The battery-shaped wireless device according to claim 1, further comprising:
a nonvolatile semiconductor memory unit disposed in the housing, wherein
the control circuit is further configured to cause the wireless module to transmit data stored in the nonvolatile semiconductor memory unit through the wireless signal.

16. The battery-shaped wireless device according to claim 15, wherein
the data stored in the nonvolatile semiconductor memory unit are encrypted.

17. The battery-shaped wireless device according to claim 15, wherein
the data stored in the nonvolatile semiconductor memory unit include identification information of the battery-shaped wireless device.

18. The battery-shaped wireless device according to claim 15, wherein
the data stored in the nonvolatile semiconductor memory unit include product information of the battery-shaped wireless device.

19. The battery-shaped wireless device according to claim 1, further comprising:
a speaker disposed in the housing and configured to generate a sound in response to a signal received through the wireless module.

20. A battery-shaped wireless device, comprising:
a housing having an exterior shape of a standardized battery and including positive and negative terminals at locations of the housing corresponding to locations of positive and negative terminals in the standardized battery:
a wireless module disposed in the housing and configured to generate a wireless signal; and
a battery module disposed in the housing and configured to supply power to the wireless module and through the positive and negative terminals to devices electrically connected to the positive and negative terminals.
